(19) United States
(12) Patent Application Publication
(10) Pub. No.: US 2007/0211839 A1
(43) Pub. Date: Sep. 13, 2007

(54) SAMPLING TIMING MONITORING SYSTEM AND ENDOSCOPE HAVING THE SAME

(75) Inventor: Tadaaki Suda, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/682,455

(22) Filed: Mar. 6, 2007

(30) Foreign Application Priority Data
Mar. 8, 2006 (JP) 2006-062291
Mar. 8, 2006 (JP) 2006-062292

(51) Int. Cl. H04L 7/00

(52) U.S. Cl. 375/354

(57) ABSTRACT

There is provided a sampling timing monitoring system, which includes at least one abnormal state detection circuit. The at least one abnormal state detection circuit includes a pulse generation circuit that generates a pulse having a pulse width corresponding to a relationship between timing of a driving signal for driving an image pickup device and timing of a sampling signal to be supplied to a sampling circuit carrying out correlated double sampling for an analog output signal outputted by the image pickup device, and a detection circuit that detects an abnormal state of the timing of the sampling signal with respect to the timing of the driving signal in accordance with the pulse width of the pulse generated by the pulse generation circuit.

### BACKGROUND OF THE INVENTION

The present invention relates to a sampling circuit which samples an analog output signal from an image pickup device, and particularly to detection of an abnormal state of the sampling circuit.

CDS (Correlated Double Sampling) circuits are widely used for devices having an image pickup device such as a CCD (Charge-Coupled Device). The CDS circuit uses a sampling pulse for sampling the analog output signal from the CCD during an image signal period, and uses a sampling pulse for sampling the analog output signal during a feedthrough period. The CDS circuit is capable of outputting an image signal from which noise is eliminated, by obtaining a difference between a voltage of the analog output signal sampled during the image signal period and a voltage of the analog output signal sampled during the feedthrough period. During the feedthrough period, the analog output signal from the CCD contains reset noise. The analog output signal outputted during the image signal period corresponds to a combination of the image signal and the reset noise.

Therefore, by obtaining the difference between the analog output signal in the image signal period and the output signal during the feedthrough period, the image signal from which the reset noise is eliminated can be obtained.

If the sampling pulses being supplied to the CDS circuit have wrong timing, the CDS circuit becomes unable to properly sample the analog output signal. As a result, an abnormal image may be displayed on a monitor. For this reason, the sampling pulse for sampling the analog output signal during the image signal period is generated to be supplied to the CDS circuit within a predetermined time range in the image signal period, and the sampling pulse for sampling the analog output signal during the feedthrough period is generated to be supplied to the CDS circuit within a predetermined time range in the feedthrough period.

Japanese Patent Provisional Publication No. 2002-27335 discloses an electronic endoscope having an automatic sampling pulse adjustment device capable of automatically adjusting timing of sampling pulses for sampling an analog output signal outputted from an image pickup device. The automatic sampling pulse adjustment device measures a propagation delay time which is a time from the output of a driving signal for a CCD to the input of the analog output signal of the CCD to a CDS circuit, and adjusts the phase of the sampling pulse in accordance with the measured propagation delay time. Therefore, the automatic sampling pulse adjustment device is able to easily adjust the timing of the sampling pulse even if the propagation delay time varies, for example, due to the difference in length of an insertion unit attached to the electronic endoscope.

If an observation image, which is outputted from an electronic endoscope, is in an abnormal state, the electronic endoscope is inspected to diagnose the cause of the abnormal state of the outputted observation image. Since various types of circuits are provided around the CCD, the inspection has to be conducted for various types of checking items. Frequently, such an inspection is conducted without checking the timing of sampling pulses, assuming that the sampling pulses are in a normal state. However, if an inspector misses abnormal conditions of the timing of the sampling pulses, the abnormal state of the observation image can not be fixed regardless of the fact that the inspector checks the CCD and the various types of circuits around the CCD. In this case, time for the inspection is wasted.

As described above, the automatic sampling pulse adjustment device is able to adjust the phase of the sample pulse in response to the propagation delay time which varies depending on the length of the insertion unit attached to the electronic endoscope. However, even the automatic sampling pulse adjustment device can not turn back the abnormal timing of the sampling pulse to a normal state.

### SUMMARY OF THE INVENTION

The present invention is advantageous in that it provides an sampling timing monitoring system capable of detecting an abnormal state of timing of a sampling pulse.

According to an aspect of the invention, there is provided a sampling timing monitoring system, which includes at least one abnormal state detection circuit. The at least one abnormal state detection circuit includes a pulse generation circuit that generates a pulse having a pulse width corresponding to a relationship between timing of a driving signal for driving an image pickup device and timing of a sampling signal to be supplied to a sampling circuit carrying out correlated double sampling for an analog output signal outputted by the image pickup device, and a detection circuit that detects an abnormal state of the timing of the sampling signal with respect to the timing of the driving signal in accordance with the pulse width of the pulse generated by the pulse generation circuit.

With this configuration, it is possible to detect the abnormal state of the timing of the sampling signal.

In at least one aspect, the detection circuit includes a counter that obtains a value corresponding to the pulse width of the pulse generated by the pulse generation circuit, and a judgment circuit that judges whether the value obtained by the counter is within a predetermined range. In this case, the detection circuit detects the abnormal state of the timing of the sampling signal in accordance with a judgment result of the judgment circuit.

Such a configuration makes it possible to measure the pulse width corresponding to the relationship between the driving signal and the sampling signal with the counter and to detect the abnormal state of the sampling signal in accordance with a measured value.

In at least one aspect, the detection circuit judges that the timing of the sampling signal is in the abnormal state if the judgment circuit judges that the value obtained by the counter is not within the predetermined range, and judges that the timing of the sampling signal is in a normal state if the judgment circuit judges that the value obtained by the counter is within the predetermined range.

In at least one aspect, the detection circuit includes an integrator circuit that integrates the pulse generated by the pulse generation circuit, and a voltage comparator that judges whether an output voltage of the integrator circuit satisfies a predetermined condition. In this case, the detection circuit detects the abnormal state of the timing of the sampling signal in accordance with a judgment result of the voltage comparator.

Such a configuration makes it possible to convert the pulse width corresponding to the relationship between the driving signal and the sampling signal to a voltage level and to detect the abnormal state of the sampling signal in accordance with the voltage level.

In at least one aspect, the predetermined condition is a predetermined upper voltage. In this case, the detection circuit judges that the timing of the sampling signal is in the abnormal state if the voltage comparator judges that the output voltage of the integrator is larger than the predetermined upper voltage, and judges that the timing of the sampling signal is in a normal state if the voltage comparator judges that the output voltage of the integrator is lower than or equal to the predetermined upper voltage.

In at least one aspect, the pulse width of the pulse generated by the pulse generation circuit corresponds to a period from falling of the driving signal to rising of the sampling signal.

In at least one aspect, the at least one abnormal state detection circuit comprises two abnormal state detection circuits each of which includes the pulse generation circuit and the detection circuit. In this case, the driving signal of a first abnormal state detection circuit of the two abnormal state detection circuits is a reset gate signal, and the sampling signal of the first abnormal state detection circuit is a first sampling signal for sampling a part of the analog output signal corresponding to a feedthrough period. Further, the driving signal of a second abnormal state detection circuit of the two abnormal state detection circuits is a horizontal driving signal, and the sampling signal of the second abnormal state detection circuit is a second sampling signal for sampling a part of the analog output signal corresponding to an image signal period.

In at least one aspect, the sampling timing monitoring system includes an abnormal state indication unit configured to indicate the abnormal state of the timing of the sampling signal if the abnormal state of the timing of the sampling signal is detected by the detection unit.

In at least one aspect, the at least one abnormal state detection circuit comprises two abnormal state detection circuits each of which includes the pulse generation circuit and the detection circuit. In this case, the abnormal state indication unit indicates the abnormal state of the timing of the sampling signal if the abnormal state of the timing of the sampling signal is detected by at least one of the two abnormal state detection circuits.

In at least one aspect, the abnormal state indication unit indicates the abnormal state by emission of light.

In at least one aspect, the pulse generation circuit includes a D-flip-flop having a reset input terminal, and the driving signal is inputted to a clock input terminal of the D-flip-flop, and the sampling signal is inputted to the reset input terminal of the D-flip-flop.

In at least one aspect, the sampling timing monitoring system includes a programmable integrated circuit which incorporates the at least one abnormal state detection circuit.

In at least one aspect, the at least one abnormal state detection circuit comprises two abnormal state detection circuits each of which includes the pulse generation circuit and the detection circuit. In this case, a first driving signal is inputted to a first abnormal state detection circuit of the two abnormal state detection circuits as the driving signal of the first abnormal state detection circuit, and a second driving signal is inputted to a second abnormal state detection circuit of the two abnormal state detection circuits as the driving signal of the second abnormal state detection circuit. In this configuration, the sampling timing monitoring system may include a driving signal state detection circuit configured to detect an abnormal state of a time difference between the first and second driving signals.

In at least one aspect, the first driving signal is a reset gate signal and the second driving signal is a horizontal driving signal. In this case, the driving signal state detection circuit detects the abnormal state of the time difference between the reset gate signal and the horizontal driving signal by judging whether timing of rising of the reset gate signal and timing of rising of the horizontal driving signal coincide with each other.

According to another aspect of the invention, there is provided an endoscope, which includes an image pickup device that outputs an analog output signal corresponding to an image of a subject, a sampling circuit that carries out correlated double sampling for the analog output signal outputted by the image pickup device, and at least one abnormal state detection circuit. In this configuration, the at least one abnormal state detection circuit includes a pulse generation circuit that generates a pulse having a pulse width corresponding to a relationship between timing of a driving signal for driving the image pickup device and timing of a sampling signal to be supplied to the sampling circuit, and a detection circuit that detects an abnormal state of the timing of the sampling signal with respect to the timing of the driving signal in accordance with the pulse width of the pulse generated by the pulse generation circuit.

With this configuration, it is possible to detect the abnormal state of the timing of the sampling signal.

In at least one aspect, the detection circuit includes a counter that obtains a value corresponding to the pulse width of the pulse generated by the pulse generation circuit, and a judgment circuit that judges whether the value obtained by the counter is within a predetermined range. In this case, the detection circuit detects the abnormal state of the timing of the sampling signal in accordance with a judgment result of the judgment circuit.

Such a configuration makes it possible to measure the pulse width corresponding to the relationship between the driving signal and the sampling signal with the counter and to detect the abnormal state of the sampling signal in accordance with a measured value.

In at least one aspect, the detection circuit includes an integrator circuit that integrates the pulse generated by the pulse generation circuit, and a voltage comparator that judges whether an output voltage of the integrator circuit satisfies a predetermined condition. In this case, the detection circuit detects the abnormal state of the timing of the sampling signal in accordance with a judgment result of the voltage comparator.

Such a configuration makes it possible to convert the pulse width corresponding to the relationship between the driving signal and the sampling signal to a voltage level and to detect the abnormal state of the sampling signal in accordance with the voltage level.

### BRIEF DESCRIPTION OF THE ACCOMPANYING DRAWINGS

FIG. 1 is a block diagram of an electronic endoscope according to a first embodiment of the invention.

FIGS. 2A, 2B, 2C, 2D and 2E respectively illustrate timing charts for a horizontal driving signal, a reset gate signal, an analog output signal, a black sampling signal, and an image sampling signal.

FIGS. 2F and 2G respectively illustrate timing charts of an output signal of a flip-flop of a detection circuit for a black sampling signal, and an output signal of a flip-flop of a detection circuit for an image sampling signal.

FIG. 3 is a circuit diagram of an abnormal state detection circuit provided in a programmable IC according to the first embodiment.

FIG. 4 shows a truth table of a flip-flop provided in the abnormal state detection circuit.

FIG. 5 is a circuit diagram of an abnormal state detection circuit provided in a programmable IC according to a second embodiment.

FIGS. 6A, 6B, 6C and 6D show examples of signals generated in the abnormal state detection circuit shown in FIG. 5 when driving and sampling signals in a normal state are inputted to the abnormal state detection circuit.

FIGS. 7A, 7B, 7C, 7D and 7E are timing charts respectively illustrating a horizontal driving signal, a reset gate signal, an analog output signal, a black sampling signal, and an image sampling signal, for explaining a case where each of the black sampling signal and the image sampling signal is in an abnormal state.

FIGS. 8A, 8B, 8C and SD show examples of signals generated in the abnormal state detection circuit shown in FIG. 5 when the driving and sampling signals in the abnormal state shown in FIGS. 7A to 7E are inputted to the abnormal state detection circuit.

FIG. 9 is a circuit diagram illustrating an example of the driving signal state detection circuit.

### DETAILED DESCRIPTION OF THE EMBODIMENTS

Hereinafter, embodiments according to the invention are described with reference to the accompanying drawings.

### First Embodiment

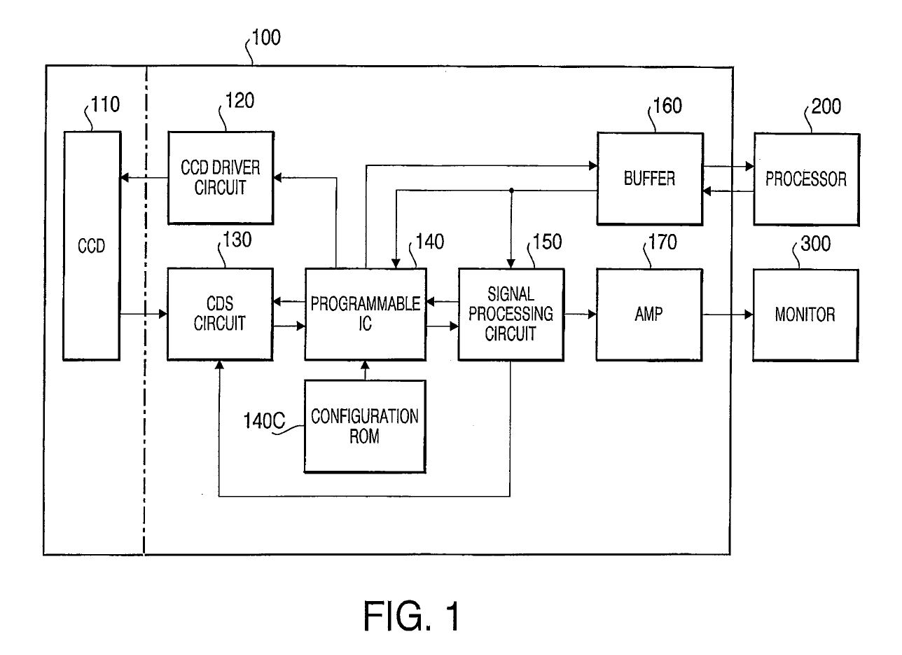

FIG. 1 is a block diagram of an electronic endoscope 100 (hereafter, referred to as an endoscope 100) according to a first embodiment of the invention. The endoscope 100 includes a CCD 110 (i.e., an image pickup device), a CCD driver circuit 120, a CDS (Correlated Double Sampling) circuit 130, a programmable IC 140, a configuration ROM 140C, a signal processing circuit 150, a buffer 160, and an amplifier 170. To the endoscope 100, a processor 200 and a monitor 300 are connected. The endoscope 100 includes an insertion unit which is inserted into a body cavity of a subject, an operation unit to be operated by an operator to control the endoscope 100, and an image processing device. The functional units shown in FIG. 1 are provided in the insertion unit, the operation unit, and the image processing device.

The CCD 110 is provided at the tip end of the insertion unit. The CCD 110 has a photoreception surface which receives light reflected from the subject receiving light emitted from the tip end of the insertion unit. On the photoreception surface of the CCD 110, a number of photodiodes, which respectively correspond to pixels, are arranged. Electronic charges accumulated in each photodiode in response to the amount of the light impinging on each photodiode are read and transferred to another cell in accordance with driving signals (e.g., a vertical driving signal) provided for the CCD 110, and thereafter are outputted from the CCD 110 as an analog output signal in accordance with a horizontal driving signal and a reset gate signal.

In the insertion unit of the endoscope 100, components including cables for connecting the CCD 110, the CCD driving circuit 120, and the CDS circuit 130 with respect to each other are provided. The analog output signal outputted by the CCD 110 is inputted to the CDS circuit 130. The driving signals (e.g., the horizontal and vertical driving signals and the reset gate signal) and power voltages are supplied to the CCD 110 via the CCD driver circuit 120.

The CCD driver circuit 120 generates the driving signals (e.g., the horizontal and vertical driving signals and the reset gate signal) and supplies them to the CCD 110, and supplies the horizontal driving signal and the reset gate signal to the programmable IC 140.

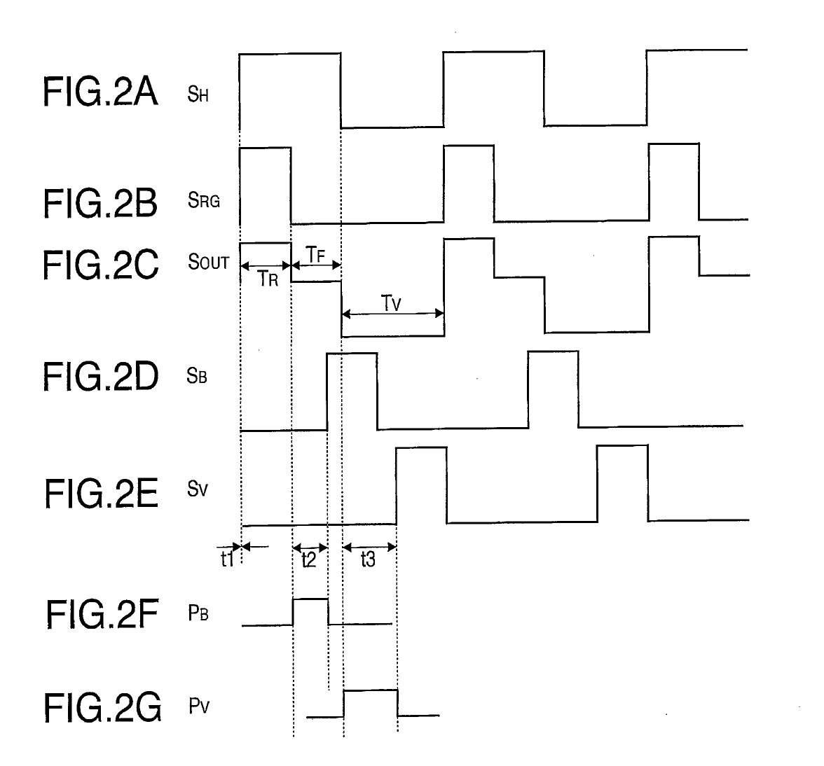

The CDS circuit 130 is configured to eliminate noise such as reset noise on signals outputted from the CCD 110. As described below with reference to FIGS. 2A to 2G, the analog output signal from the CCD 110 has a reset period, a feedthrough period and an image signal period. In the CDS circuit 130, a black level which is a voltage of the analog output signal during the feedthrough period is sampled, and an image level which is a voltage of the analog output signal during the image signal period is sampled. The CDS circuit 130 outputs a digital image signal corresponding to a difference between the black level and the image level. The CDS circuit 130 includes various circuits (e.g., an AGC (Automatic Gain Control) circuit and an A-D converter) for processing the analog output signal to generate the digital video signal.

The signal processing circuit 150 generates sampling pulses such as a black sampling signal and an image sampling signal, and supplies the black and image sampling signals to the CDS circuit 130. The black sampling signal is used by the CDS circuit 130 to obtain the black level, and the image sampling signal is used by the CDS circuit 130 to obtain the image level.

The programmable IC 140 is a programmable integrated circuit such as an FPGA (Field Programmable Gate Array) or a CPLD (Complex Programmable Logic Device). Although, from the viewpoint of mass production, the unit price of the FPGA is higher than that of an IC such as an ASIC (Application Specific Integrated Circuit), the programmable IC has advantages in that the programmable IC can be made without the need of design and production of a mask pattern. Therefore, it is desirable to employ such a programmable IC in endoscopes because endoscopes are devices which are produced in a small amount of production per a model, and therefore the use of the programmable IC is more effective in such a device which a vender designs attaching importance on reduction of cost for development and not attaching importance on reduction of manufacturing cost.

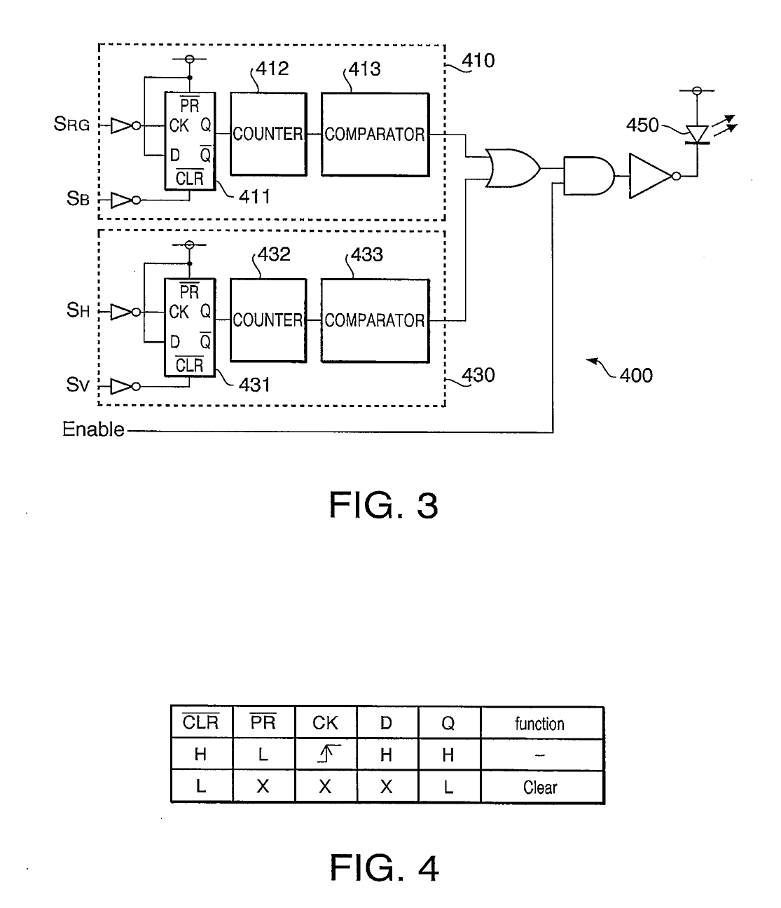

The programmable IC 140 includes a control circuit for controlling the entire part of the endoscope 100, and an abnormal state detection circuit 400 for detecting an abnormal state of timing of the sampling pulses (see FIG. 3). The abnormal state detection circuit 400 has a function of detecting the abnormal state of the black sampling signal and the image sampling signal. It is understood that the abnormal state detection circuit 400 can be incorporated into the endoscope 100 by simply adding the abnormal state detection circuit 400 in the programmable IC 140. In other words, the abnormal state detection circuit 400 can be incorporated into the endoscope 100 without complicating the configuration of circuit in the endoscope 100.

The configuration ROM 140C stores a program for configuring and setting up the programmable IC 140 (i.e., at least configuring the abnormal state detection circuit 400 in the programmable IC 140) of which programmable elements are volatile. If a CPLD is used as the programmable IC 140, the programming of the CPLD is required only one time during the manufacturing process. Therefore, the abovementioned configuration process can be omitted.

The signal processing circuit 150 includes various circuits such as a DSP (Digital Signal Processor), an image memory, and a D-A converter. The signal processing circuit 150 subjects the digital image signal transmitted from the programmable IC 140 to predetermined signal processing. For example, the signal processing circuit 150 subjects the digital image signal to a predetermined process to generate an analog video signal such as RGB signals. The signal processing circuit 150 further includes a signal generator which generates the black and image sampling signals. The black and image sampling signals generated by the signal generator are supplied to the CDS circuit 130 and the programmable IC 140.

The analog video signal generated by the signal processing circuit 150 is amplified by the amplifier 170 and is outputted from the endoscope 100 as a predetermined video signal to the monitor 300. The operator is able to observe the image obtained by the CCD 110 on the monitor 300.

The processor 200 is a signal processing device incorporating a light source. The processor has a user interface configured to accept a user operation to be conducted by an operator (e.g., an inspector) through a keyboard, and to display various types of information concerning conditions of the endoscope 100. The processor 200 has a controller connected to the programmable IC 140 and the signal processing circuit 150 via the buffer 160 to control the programmable IC 140 and the signal processing circuit 150.

In the above mentioned configuration of the endoscope 100, the horizontal driving signal and the reset gate signal are generated in the CCD driver circuit 120, and the black and image sampling signals are generated in the signal processing circuit 150. However, the horizontal driving signal and the reset gate signal may be generated in one of the programmable IC 140 and the signal processing circuit 150, and the black and image sampling signals may be generated in one of the CCD driver circuit 120 and the programmable IC 140.

FIGS. 2A, 2B, 2C, 2D and 2E respectively illustrate timing charts for the horizontal driving signal (S_{H}), the reset gate signal (S_{RG}), the analog output signal (S_{OUT}) of the CCD 110, the black sampling signal (S_{B}) and the image sampling signal (S_{V}). More specifically, FIG. 2A illustrates outputting timing of the horizontal driving signal S_{H} outputted by the CCD driver circuit 120. FIG. 2B illustrates outputting timing of the reset gate signal S_{RG} outputted by the CCD driver circuit 120. A cycle of the analog output signal of the CCD 110 is determined in accordance with the horizontal driving signal S_{H} and the reset gate signal S_{RG}. The outputting timing of the horizontal driving signal S_{H} and the reset gate signal S_{RG} are adjusted so that the rising edge of the horizontal driving signal S_{H} and the rising edge of the reset gate signal S_{RG} coincide with each other.

FIG. 2C illustrates the timing of the analog output signal (S_{OUT}) of the CCD 110. As shown in FIG. 2C, the analog output signal of the CCD 110 has a reset period T_{R}, a feedthrough period T_{F}, and an image signal period T_{V}. The reset period T_{R} corresponds to a pulse width of the reset gate signal S_{RG}. During the feedthrough period, only the reset noise determined in the reset period T_{R} is outputted as the analog output signal. The image signal period T_{V} corresponds to a pulse width of the horizontal driving signal S_{H}. During the image signal period T_{V}, a signal corresponding to a combination of the reset noise and an image signal detected by each pixel is outputted by the CCD 110 as the analog output signal.

It should be noted that the shape of the analog output signal shown in FIG. 2C is illustrated schematically for the purpose of explaining the outputting timing. In practice, the rising and falling edges of the analog output signal changes gradually along a time-axis.

FIG. 2D illustrates outputting timing of the black sampling signal S_{B} outputted by the signal processing circuit 150. FIG. 2E illustrates outputting timing of the image sampling signal S_{V} outputted by the signal processing circuit 150. In the CDS circuit 130, the black and image levels are sampled, respectively, at times of the rising edges of the black and image sampling signals S_{B} and S_{V}. The timing of the black sampling signal S_{B} is adjusted so that the rising edge of the black sampling signal S_{B} is located approximately at the vicinity of the center of the feedthrough period T_{F} because there is a possibility that the signal level of the analog output signal S_{OUT} at each of the start and end portions of the feedthrough period T_{F} is affected by signal levels in neighboring periods (T_{R} or T_{V}). The timing of the image sampling signal S_{V} is adjusted so that the rising edge of the image sampling signal S_{V} is located approximately at the center of the image signal period T_{V} because there is a possibility that the signal level of the analog output signal S_{OUT} at each of the start and end portions of the image signal period T_{V} is affected by neighboring periods (T_{F} or T_{R}).

In practice, a delay time from the output of the driving signals to the input of the analog output signal S_{OUT} to the CDS circuit 130 is considered to determine the outputting timing of the black and image sampling signals S_{B} and S_{V}. That is, the black and image sampling signals S_{B} and S_{V} are delayed from the output timing of the driving signals by a predicted delay time.

Further, the timing of the black sampling signal S_{B} is watched with respect to the reset gate signal S_{RG}, and the timing of the image sampling signal S_{V} is watched with respect to the horizontal driving signal S_{H}. If the timing of the black sampling signal S_{B} is not in a predetermined timing range or the timing of the image sampling signal SV is not in a predetermined timing range, the endoscope 100 judges that the state of the sampling signals is in an abnormal state.

In FIGS. 2A to 2E, the time difference between the rising edge of the horizontal driving signal S_{H} and the rising edge of the reset gate signal S_{RG} is defined as t1. The time difference between the falling edge of the reset gate signal S_{RG} and the rising edge of the black sampling signal S_{B} is defined as t2. The time difference between the falling edge of the horizontal driving signal S_{H} and the rising edge of the image sampling signal S_{V} is defined as t3.

FIG. 3 is a circuit diagram of the abnormal state detection circuit 400 provided in the programmable IC 140. The abnormal state detection circuit 400 includes a detection circuit 410 for the black sampling signal, a detection circuit 430 for the image sampling signal, and an LED 450. The detection circuit 410 for the black sampling signal includes a flip-flop 411, a counter 412, and a comparator 413. The detection circuit 430 for the image sampling signal includes a flip-flop 431, a counter 432, and a comparator 433.

Each of the flip-flops 411 and 431 is a D-type flip-flop having a reset inverse terminal ( C̅LR) and a preset inverse terminal ( P̅R). A clock terminal (CK) of each of the flip-flops 411 and 431 uses a rising edge of an inputted clock signal. In this embodiment, each of a D-terminal and the P̅R terminal of each of the flip-flops 411 and 431 is fixed to a high level. FIG. 4 shows a truth table of the flip-flop 411 (431).

In the detection circuit 410 for the black sampling signal, the inverse of the reset gate signal S_{RG} is inputted to the CK terminal of the flip-flop 411. Therefore, the flip-flop 411 outputs a value “H” from a Q terminal in response to the falling edge of the reset gate signal S_{RG}. To the C̅LR terminal, the inverse of the black sampling signal S_{B} is inputted. Therefore, when the black sampling signal S_{B} is at a HIGH level, a Low level is inputted to the C̅LR terminal and the flip-flop 411 is cleared (i.e., the value of the Q terminal changes to a Low level). That is, the Q terminal of the flip-flop 411 changes to a High level at the falling edge of the reset gate signal S_{RG}, and changes to a Low level when the High level of the black sampling signal S_{B} is inputted thereto.

In summary, the flip-flop 411 outputs a pulse P_{B} (see FIG. 2F) having a pulse width corresponding to a time period from the falling of the reset gate signal S_{RG} and the rising of the black sampling signal S_{B}. The flip-flop 411 outputs pulses P_{B} sequentially in response to the input of pulses of the reset gate signal S_{RG} and the black sampling signal S_{B}.

To the counter 412, the pulses P_{B} are sequentially inputted. The counter 412 counts the pulse width t2 of the pulse P_{B}. The counter 412 may be configured to count the pulse P_{B} using clock pulses having a cycle T₂ smaller than the pulse width t2 (T₂<<t₂).

To the comparator 413, an output (i.e., a count result) of the counter 412 is inputted. The comparator 413 compares the count result of the counter 412 with a predetermined value. To the comparator 413, a lower limit t2_{MIN} and an upper limit t2_{MAX} of the pulse width t2 used to make a judgment on whether the pulse width t2 is within the time period defined by the lower limit t2ₘᵢₙ and the upper limit t2_{MAX} (i.e., whether the count result t2 satisfies a condition t2ₘᵢₙ≦t2≦t2_{MAX}) have been set. The comparator 413 outputs a Low level if t2_{MIN}≦t2≦t2_{MAX} is satisfied, and outputs a High level if t2<t2_{MIN} or t2_{MAX}<t2 is satisfied. The lower limit t2_{MIN} and the upper limit t2_{MAX} can be set to the comparator 413 from the processor 200.

In the detection circuit 430 for the image sampling signal, the inverse of the horizontal driving signal S_{H} is inputted to the CK terminal of the flip-flop 431. Therefore, the flip-flop 431 outputs a value “H” from a Q terminal in response to the falling edge of the horizontal driving signal S_{H}. To the C̅LR terminal, the inverse of the image sampling signal S_{V} is inputted. Therefore, when the image sampling signal S_{V} is at a HIGH level, a Low level is inputted to the C̅LR terminal and the flip-flop 431 is cleared (i.e., the value of the Q terminal changes to a Low level). That is, the Q terminal of the flip-flop 431 changes to a High level at the falling edge of the horizontal driving signal S_{H}, and changes to a Low level when the High level of the image sampling signal S_{V} is inputted thereto.

In summary, the flip-flop 431 outputs a pulse P_{V} (see FIG. 2G) having a pulse width corresponding to a time period from the falling of the horizontal driving signal S_{H} and the rising of the image sampling signal S_{V}. The flip-flop 431 outputs pulses P_{V} sequentially in response to the input of pulses of the horizontal driving signal S_{H} and the image sampling signal S_{V}.

To the counter 432, the pulses P_{V} are sequentially inputted. The counter 432 counts the pulse width t3 of the pulse P_{V}. The counter 432 may be configured to count the pulse P_{V} using clock pulses having a cycle T₃ smaller than the pulse width t3 (T₃<<t₃).

To the comparator 433, an output (i.e., a count result) of the counter 432 is inputted. The comparator 433 compares the count result of the counter 432 with a predetermined value. To the comparator 433, a lower limit t3_{MIN} and an upper limit t3_{MAX} of the pulse width t3 used to make a judgment on whether the pulse width t3 is within the time period defined by the lower limit t3_{MIN} and the upper limit t3_{MAX} (i.e., whether the count result t3 satisfies a condition t3_{MIN}≦t3≦t3_{MAX}) have been set. The comparator 433 outputs a Low level if t3_{MIN}≦t3≦t3_{MAX} is satisfied, and outputs a High level if t3<t3_{MIN} or t3_{MAX}<t3 is satisfied. The lower limit t3_{MIN} and the upper limit t3_{MAX} can be set to the comparator 433 from the processor 200.

The LED 450 is lit when the abnormal state is detected in at least one of the detection circuit 410 for the black sampling signal and the detection circuit 430 for the image sampling signal (if “Enable” is High). That is, the LED 450 is lit when at least one of the output levels of the comparators 413 and 433 is High. In the abnormal state detection circuit 400, a constant voltage (e.g., 5V) is supplied to an anode terminal of the LED 450 so that the LED 450 is lit when an output of a NOT gate is Low (e.g., 0V). With this configuration, it is possible to notify the inspector of the abnormal state of the black sampling signal S_{B} or the image sampling signal S_{V} through an ON state of the LED 450.

The LED 450 may be placed in the vicinity of the programmable IC 140 on a print circuit board provided in the endoscope 100. Alternatively, the LED 450 may be placed at another position on the print circuit board. The abnormal state of the black sampling signal S_{B} or the image sampling signal S_{V} may be indicated on the monitor 300, for example, by generating information for representing the abnormal state in the programmable IC 140 and outputting the information from the programmable IC 140 to the monitor 300.

As described above, according to the first embodiment, it is possible to notify the inspector of the abnormal state of the black sampling signal S_{B} or the image sampling signal S_{V}. The state of the Enable signal can be controlled from the processor 200. To conduct the inspection of the endoscope 100, the inspector operates the processor 200 to change the state of the Enable signal from Low to High via the buffer 160. The endoscope 100 may have a circuit to control the Enable signal to keep a Low level for a certain time from the power-on of the endoscope 100 so that detection of the state of the timing of the sampling signals during an unstable period of the circuits in the endoscope 100 at the time of the power-on can be avoided. The LED 450 is lit when at least one of the comparator 413 and the comparator 433 outputs a High level. The inspector is able to adjust the timing of the black and image sampling signals by setting parameters to the signal processing circuit 150 while operating the processor 200.

In the above mentioned embodiment, the abnormal state detection circuit 400 has two detection circuits 410 and 430 for the sampling signals. However, the abnormal state detection circuit 400 may be configured to have one of the detection circuits. Even if the abnormal state detection circuit 400 is configured to have one of the detection circuits 410 and 430, the advantages of the above mentioned embodiment (i.e., to obtain the abnormal state of at least one of the sampling signals) can be achieved. In the above mentioned embodiment, only one LED is used to indicate the abnormal state of the sampling signals. However, more than one LED may be provided to indicate abnormal states of the sampling signals separately.

As described above, according to the embodiment, it is possible to detect the abnormal state of the sampling signals. The detection of the abnormal state of the sampling signals is achieved by simply adding a predetermined circuit through use of the programmable IC 140.

### Second Embodiment

Hereafter, an electronic endoscope 100B (hereafter, referred to as an endoscope 100B) according to a second embodiment of the invention is described. Since a general configuration of the endoscope 100B according to the second embodiment is substantially the same as that of the endoscope 100 according to the first embodiment show in FIG. 1, and the feature of the endoscope 100B is that the programmable IC 140 has an abnormal state detection circuit 500 in place of the abnormal state detection circuit 400, the endoscope 100B according to the second embodiment is explained below with reference to FIG. 1 and FIGS. 2A to 2E.

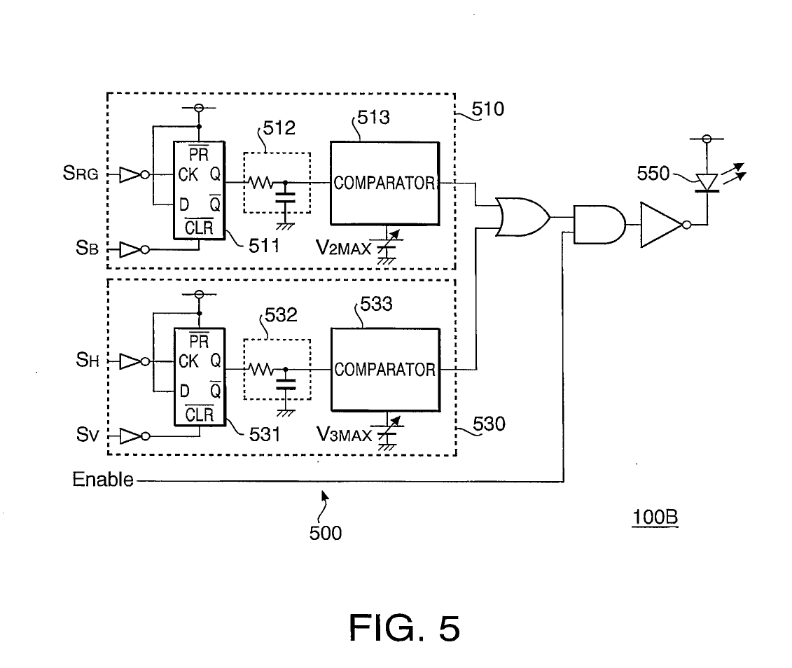

FIG. 5 is a circuit diagram of the abnormal state detection circuit 500 provided in the programmable IC 140. The abnormal state detection circuit 500 includes a detection circuit 510 for the black sampling signal, a detection circuit 530 for the image sampling signal, and an LED 550. The detection circuit 510 for the black sampling signal includes a flip-flop 511, an integrator circuit 512, and a comparator 513. The detection circuit 530 for the image sampling signal includes a flip-flop 531, an integrator circuit 532, and a comparator 533.

Each of the flip-flops 511 and 531 is a D-type flip-flop having a reset inverse terminal ( C̅LR) and a preset inverse terminal ( P̅R). A clock terminal (CK) of each of the flip-flops 511 and 531 uses a rising edge of an inputted clock signal. In this embodiment, each of a D-terminal and the P̅R terminal, of each of the flip-flops 511 and 531 is fixed to a high level. The truth table of the flip-flop 411 (431) shown in FIG. 4 is also applied to the function of each of the flip-flops 511 and 531.

In the detection circuit 510 for the black sampling signal, the inverse of the reset gate signal S_{RG} is inputted to the CK terminal of the flip-flop 511. Therefore, the flip-flop 511 outputs a value “H” from a Q terminal in response to the falling edge of the reset gate signal S_{RG}. To the C̅LR terminal, the inverse of the black sampling signal S_{B} is inputted. Therefore, when the black sampling signal S_{B} is at a High level, a Low level is inputted to the C̅LR terminal and the flip-flop 511 is cleared (i.e. the value of the Q terminal changes to a Low level). That is, the Q terminal of the flip-flop 511 changes to a High level at the falling edge of the reset gate signal S_{RG}, and changes to a Low level when the black sampling signal S_{B} is inputted thereto.

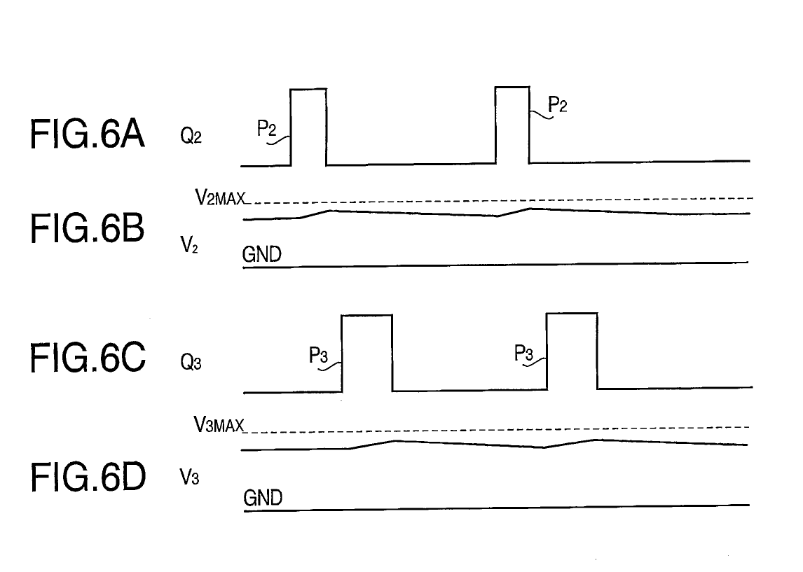

In summary, the flip-flop 511 outputs a pulse P₂ (see FIG. 6A) having a pulse width corresponding to a time period from the falling of the reset gate signal S_{RG} and the rising of the black sampling signal S_{B}. The flip-flop 511 outputs a signal Q₂ carrying pulses P₂ sequentially in response to the input of pulses of the reset gate signal S_{RG} and the black sampling signal S_{B} as shown in FIG. 6A.

To the integrator circuit 512, the signal Q₂ outputted by the flip-flop 511 is inputted. The integrator circuit 512 outputs a voltage V₂ by integrating a voltage level of the signal Q₂ (see FIG. 6B). The waveform of the voltage V₂ has a peak level at timing of the falling edge of the pulse P₂ on the signal Q₂.

To the comparator 513, the voltage V₂ outputted by the integrator circuit 512 is inputted. The comparator 513 compares the voltage V₂ with an upper voltage limit V₂max which has been set to the comparator 513 in advance. The comparator 513 judges whether the voltage V₂ is lower than or equal to the upper voltage limit V_{2MAX} (i.e., whether V₂≦V_{2MAX} holds). If V₂≦V_{2MAX} holds, the comparator 513 outputs a Low level. If V₂>V_{2MAX} holds, the comparator 513 outputs a High level. The upper voltage limit V_{2MAX} can be set to the comparator 513 from the processor 200.

In the detection circuit 530 for the image sampling signal, the inverse of the horizontal driving signal S_{H} is inputted to the CK terminal of the flip-flop 531. Therefore, the flip-flop 531 outputs a value “H” from a Q terminal in response to the falling edge of the horizontal driving signal S_{H}. To the C̅LR terminal, the inverse of the image sampling signal S_{V} is inputted. Therefore, when the image sampling signal S_{V} is at a High level, a Low level is inputted to the C̅LR terminal and the flip-flop 531 is cleared (i.e., the value of the Q terminal changes to a Low level). That is, the Q terminal of the flip-flop 531 changes to a High level at the falling edge of the horizontal driving signal S_{H}, and changes to a Low level when the high level of the image sampling signal S_{V} is inputted thereto.

In summary, the flip-flop 531 outputs a pulse P₃ (see FIG. 6C) having a pulse width corresponding to a time period from the falling of the horizontal driving signal S_{H} and the rising of the image sampling signal S_{V}. The flip-flop 531 outputs a signal Q₃ carrying pulses P₃ sequentially in response to the input of pulses of the horizontal driving signal S_{H} and the image sampling signal S_{V} as shown in FIG. 6C.

To the integrator circuit 532, the signal Q₃ outputted by the flip-flop 531 is inputted. The integrator circuit 532 outputs a voltage V₃ by integrating a voltage level of the signal Q₃ (see FIG. 6D). The waveform of the voltage V₃ has a peak level at timing of the falling edge of the pulse P₃ on the signal Q₃.

To the comparator 533, the voltage V₃ outputted by the integrator circuit 532 is inputted. The comparator 533 compares the voltage V₃ with an upper voltage limit V₃max which has been set to the comparator 533 in advance. The comparator 533 judges whether the voltage V₃ is lower than or equal to the upper voltage limit V_{3MAX} (i.e., whether V₃≦V_{3MAX} holds). If V₃≦V_{3MAX} holds, the comparator 533 outputs a Low level. If V₃>V_{3MAX} holds, the comparator 533 outputs a High level. The upper voltage limit V_{3MAX} can be set to the comparator 533 from the processor 200.

The LED 550 is lit when the abnormal state is detected in at least one of the detection circuit 510 for the black sampling signal and the detection circuit 530 for the image sampling signal (if “Enable” is High). That is, the LED 550 is lit when at least one of the output levels of the comparators 513 and 533 is High. In the abnormal state detection circuit 500, a constant voltage (e.g., 5V) is supplied to an anode terminal of the LED 550 so that the LED 550 is lit when an output of a NOT gate is Low (e.g., 0V). With this configuration, it is possible to notify the inspector of the abnormal state of the black sampling signal S_{B} or the image sampling signal S_{V} through an ON state of the LED 550.

The LED 550 may be placed in the vicinity of the programmable IC 140 on a print circuit board provided in the endoscope 100B. Alternatively, the LED 550 may be placed at another position on the print circuit board. The abnormal state of the black sampling signal S_{B} or the image sampling signal S_{V} may be indicated on the monitor 300, for example, by generating information representing the abnormal state in the programmable IC 140 and outputting the information from the programmable IC 140 to the monitor 300.

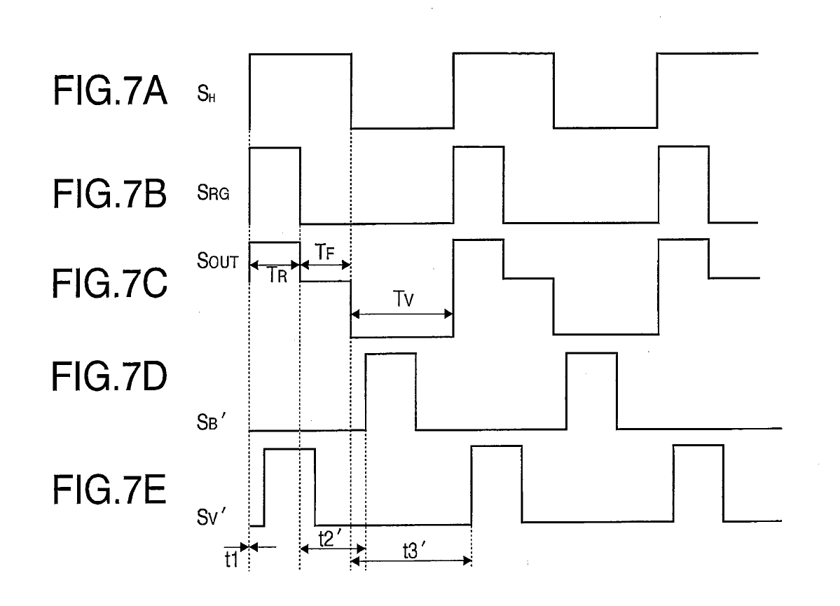

FIGS. 7A to 7E are timing charts respectively illustrating the horizontal driving signal S_{H}, the reset gate signal S_{RG}, the analog output signal S_{OUT}, a black sampling signal and an image sampling signal, for explaining a case where each of the black sampling signal and the image sampling signal is in the abnormal state. In FIGS. 7D and 7E, the abnormal black sampling signal is assigned a reference S_{B}′ and the abnormal image sampling signal is assigned a reference S_{V}′. The timing of the horizontal driving signal S_{H}, the reset gate signal S_{RG}, the analog output signal S_{OUT} shown in FIGS. 7A, 7B and 7C are the same as those show in FIGS. 2A, 2B and 2C.

In the state shown in FIG. 7D, the timing of the rising edge of the black sampling signal S_{B}′ is shifted to the right side with respect to the feedthrough period T_{F} of the analog output signal S_{OUT} (i.e., shifted toward the image signal period T_{V}). In the state shown in FIG. 7E, the timing of the rising edge of the image sampling signal S_{V}′ is shifted to the right side with respect to the image signal period T_{V} of the analog output signal S_{OUT} (i.e., shifted toward the reset period T_{R}). Since the black sampling signal S_{B}′ is shifted to the right side, the time difference t2′ between the falling edge of the reset gate signal S_{RG} and the rising edge of the black sampling signal S_{B}′ is larger than the time difference t2 shown in FIG. 2D. Since the image sampling signal S_{V}′ is shifted to the right side, the time difference t3′ between the falling edge of the horizontal driving signal S_{H} and the rising edge of the image sampling signal S_{V}′ is larger than the time difference t3 shown in FIG. 2E.

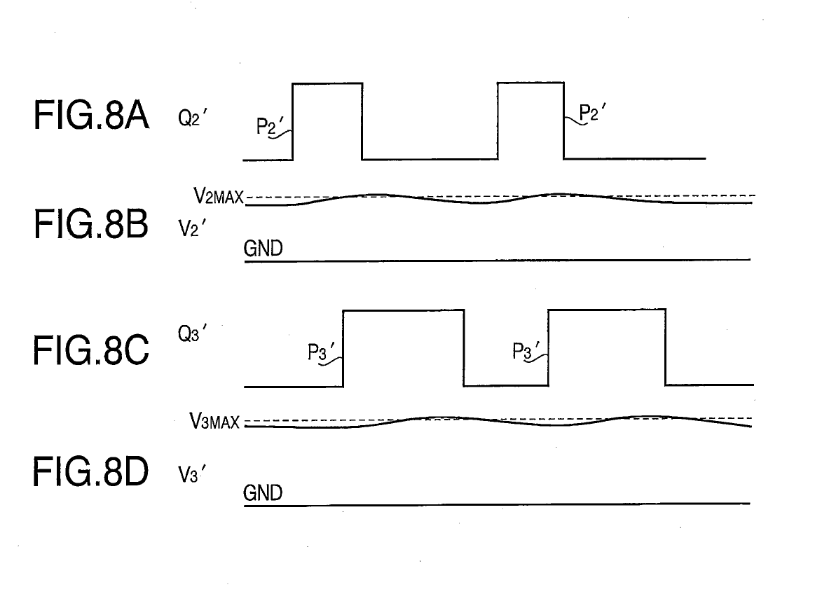

FIGS. 8A to 8D show signals generated in the abnormal state detection circuit 500 when the signals including in the abnormal sampling signals shown in FIGS. 7A to 7E are inputted to the abnormal state detection circuit 500. FIG. 8A shows a signal Q2′ outputted from the Q terminal of the flip-flop 511 when the signals shown in FIGS. 7A to 7E are inputted to the flip-flop 511. Since the pulse width of a pulse P2′ corresponds to the time difference t2′, the pulse width of the pulse P2′ is larger than the pulse width of the pulse P₂ shown in FIG. 6A. In this case, an output voltage V₂′ of the integrator circuit 512 (see FIG. 5B) becomes higher than the voltage V₂ of the normal state (see FIG. 6B). In FIG. 8B, the peak of the output voltage V2′ is higher than the upper voltage limit V_{2MAX}. Therefore, when the output voltage V₂′ changes to a state of V₂′>V_{2MAX}, the comparator 513 outputs a High level. During the state of V₂′≦V_{2MAX}, the comparator 513 outputs a Low level.

FIG. 8C shows a signal Q3′ outputted from the Q terminal of the flip-flop 531 when the signals shown in FIGS. 7A to 7E are inputted to the flip-flop 531. Since the pulse width of a pulse P3′ corresponds to the time difference t3′, the pulse width of the pulse P3′ is larger than the pulse width of the pulse P3 shown in FIG. 6C. In this case, an output voltage V₃′ of the integrator circuit 532 (see FIG. 8D) is higher than the voltage V₃ in the normal state (see FIG. 6D). In FIG. 8D, the peak of the output voltage V3′ becomes higher than the upper voltage limit V_{3MAX}. Therefore, when the output voltage V₃′ changes to a state of V₃′>V_{3MAX}, the comparator 533 outputs a High level. During the state of V₃′≦V_{3MAX}, the comparator 533 outputs a Low level.

As described above, according to the second embodiment, it is possible to notify the inspector of the abnormal state of the black sampling signal S_{B} or the image sampling signal S_{V}. The state of the Enable signal can be controlled from the processor 200. To conduct the inspection of the endoscope 100B, the inspector operates the processor 200 to change the state of the Enable signal from Low to High via the buffer 160. The endoscope 100B may have a circuit to control the Enable signal to keep a Low level for a certain time from the power-on of the endoscope so that detection of the state of the timing of the sampling signals during an unstable period of the circuits in the endoscope at the time of the power-on can be avoided. The LED 550 is lit when at least one of the comparator 513 and the comparator 533 outputs a High level. The inspector is able to adjust the timing of the black and image sampling signals by setting parameters to the signal processing circuit 150 while operating the processor 200.

In the second embodiment, the abnormal state detection circuit 500 has two detection circuits 510 and 530 for the sampling signals. However, the abnormal state detection circuit 500 may be configured to have only one detection circuit. Even if the abnormal state detection circuit 500 is configured to have only of detection circuit (510 or 530), the advantages of the above mentioned embodiments (i.e., to obtain the abnormal state of at least one of the sampling signals) can be achieved. In the above mentioned embodiment, only one LED is used to indicate the abnormal state of the sampling signals. However, more than one LED may be provided to indicate abnormal states of the sampling signals separately.

In the second embodiment, there is a possibility that the sampling operation is not performed in the CDS circuit 130 during the situation where the CCD 110 is driven by the horizontal driving signal S_{H} and the reset gate signal S_{RG}. In this case, the black sampling signal S_{B} and the image sampling signal S_{V} are not supplied to the CDS circuit 130. If the signal processing circuit 150 starts to supply the black sampling signal S_{B} and the image sampling signal S_{V} to the CDS circuit 130 after such a situation, the pulse width t2 or t3 may become larger regardless of the fact that the sampling signals S_{B} and S_{V} are in the normal state. In this case, the abnormal state detection circuit 500 may erroneously judge that the sampling signals are in the abnormal state regardless of the fact that the sampling signals are in the normal state. To avoid such an improper judgment, the endoscope 100B may be configured such that the Enable signal is kept at a High level only when the digital image signal (e.g., a luminance signal) is inputted to the signal processing circuit 150.

In the second embodiment, the comparators 513 and 533 are included in the programmable IC 140. However, the comparators 513 and 533 may be located outside the programmable IC 140.

As described above, according to the second embodiment, it is possible to detect the abnormal state of the sampling signals. The detection of the abnormal state of the sampling signals is achieved by simply adding a predetermined circuit through use of the programmable IC 140.

It should be noted that if a digital counter is used to detect the pulse width of the pulse P2 or P3 outputted by the flip-flop 511 or 531, it is required to use clock pulses having a cycle shorter than the pulse width of the pulse P2 or P3. The use of such a high frequency signal introduces the need for design for EMC (electromagnetic compatibility). By contrast, according to the second embodiment, the pulse width of the pulse P2 or P3 is detected by converting the pulse width to the D.C. voltage with the integrator circuit. Therefore, the design for the EMC is not required.

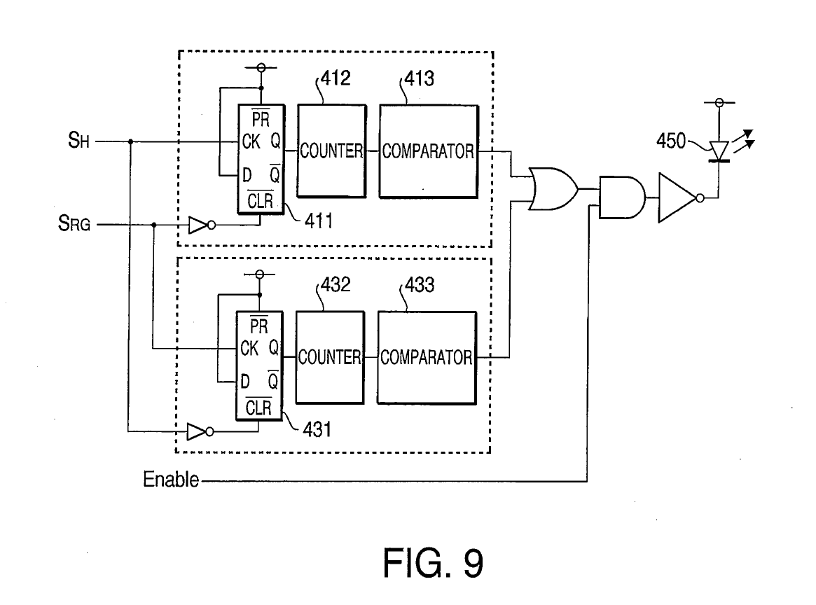

For the inspection, it is preferable to check whether the timing of the horizontal driving signal S_{H} and the timing of the reset gate signal S_{RG} are appropriate. Although the timing of the horizontal driving signal S_{H} and the reset gate signal S_{RG} can be checked using a measuring device such as an oscilloscope, the endoscope 100 may be provided with a circuit for detecting the time difference t1 between the horizontal driving signal S_{H} and the reset gate signal S_{RG} (i.e., a driving signal state detection circuit). For example, it is possible to detect whether the timing of the rising edges of the horizontal driving signal S_{H} and the reset gate signal S_{RG} coincide with each other (i.e., whether the t1 is 0) using a circuit design similar to the configuration of the abnormal state detection circuit 400 (or 500) shown in FIG. 3. FIG. 9 is a circuit diagram illustrating an example of the driving signal state detection circuit.

This application claims priority of Japanese Patent Applications Nos. P2006-062291, filed on Mar. 8, 2006, and P2006-062292, filed on Mar. 8, 2006. The entire subject matter of the applications is incorporated herein by reference.

What is claimed is:

1. A sampling timing monitoring system, comprising:
at least one abnormal state detection circuit including:
a pulse generation circuit that generates a pulse having a pulse width corresponding to a relationship between timing of a driving signal for driving an image pickup device and timing of a sampling signal to be supplied to a sampling circuit carrying out correlated double sampling for an analog output signal outputted by the image pickup device; and
a detection circuit that detects an abnormal state of the timing of the sampling signal with respect to the timing of the driving signal in accordance with the pulse width of the pulse generated by the pulse generation circuit.

2. The sampling timing monitoring system according to claim 1,
wherein the detection circuit includes:
a counter that obtains a value corresponding to the pulse width of the pulse generated by the pulse generation circuit; and
a judgment circuit that judges whether the value obtained by the counter is within a predetermined range,
wherein the detection circuit detects the abnormal state of the timing of the sampling signal in accordance with a judgment result of the judgment circuit.

3. The sampling timing monitoring system according to claim 2, wherein the detection circuit judges that the timing of the sampling signal is in the abnormal state if the judgment circuit judges that the value obtained by the counter is not within the predetermined range, and judges that the timing of the sampling signal is in a normal state if the judgment circuit judges that the value obtained by the counter is within the predetermined range.

4. The sampling timing monitoring system according to claim 1,
wherein the detection circuit includes:
an integrator circuit that integrates the pulse generated by the pulse generation circuit; and
a voltage comparator that judges whether an output voltage of the integrator circuit satisfies a predetermined condition,
wherein the detection circuit detects the abnormal state of the timing of the sampling signal in accordance with a judgment result of the voltage comparator.

5. The sampling timing monitoring system according to claim 4,
wherein the predetermined condition is a predetermined upper voltage,
wherein the detection circuit judges that the timing of the sampling signal is in the abnormal state if the voltage comparator judges that the output voltage of the integrator is larger than the predetermined upper voltage, and judges that the timing of the sampling signal is in a normal state if the voltage comparator judges that the output voltage of the integrator is lower than or equal to the predetermined upper voltage.

6. The sampling timing monitoring system according to claim 1, wherein the pulse width of the pulse generated by the pulse generation circuit corresponds to a period from falling of the driving signal to rising of the sampling signal.

7. The sampling timing monitoring system according to claim 1, wherein:
the at least one abnormal state detection circuit comprises two abnormal state detection circuits each of which includes the pulse generation circuit and the detection circuit;
the driving signal of a first abnormal state detection circuit of the two abnormal state detection circuits is a reset gate signal, and the sampling signal of the first abnormal state detection circuit is a first sampling signal for sampling a part of the analog output signal corresponding to a feedthrough period; and
the driving signal of a second abnormal state detection circuit of the two abnormal state detection circuits is a horizontal driving signal, and the sampling signal of the second abnormal state detection circuit is a second sampling signal for sampling a part of the analog output signal corresponding to an image signal period.

8. The sampling timing monitoring system according to claim 1, further comprising an abnormal state indication unit configured to indicate the abnormal state of the timing of the sampling signal if the abnormal state of the timing of the sampling signal is detected by the detection unit.

9. The sampling timing monitoring system according to claim 8, wherein:
the at least one abnormal state detection circuit comprises two abnormal state detection circuits each of which includes the pulse generation circuit and the detection circuit; and
the abnormal state indication unit indicates the abnormal state of the timing of the sampling signal if the abnormal state of the timing of the sampling signal is detected by at least one of the two abnormal state detection circuits.

10. The sampling timing monitoring system according to claim 8, wherein the abnormal state indication unit indicates the abnormal state by emission of light.

11. The sampling timing monitoring system according to claim 1, wherein
the pulse generation circuit includes a D-flip-flop having a reset input terminal; and
the driving signal is inputted to a clock input terminal of the D-flip-flop, and the sampling signal is inputted to the reset input terminal of the D-flip-flop.

12. The sampling timing monitoring system according to claim 1, further comprising a programmable integrated circuit which incorporates the at least one abnormal state detection circuit.

13. The sampling timing monitoring system according to claim 1,
wherein the at least one abnormal state detection circuit comprises two abnormal state detection circuits each of which includes the pulse generation circuit and the detection circuit,
wherein a first driving signal is inputted to a first abnormal state detection circuit of the two abnormal state detection circuits as the driving signal of the first abnormal state detection circuit, and a second driving signal is inputted to a second abnormal state detection circuit of the two abnormal state detection circuits as the driving signal of the second abnormal state detection circuit, and
wherein the sampling timing monitoring system further comprises:
a driving signal state detection circuit configured to detect an abnormal state of a time difference between the first and second driving signals.

14. The sampling timing monitoring system according to claim 1, wherein:
the first driving signal is a reset gate signal and the second driving signal is a horizontal driving signal; and
the driving signal state detection circuit detects the abnormal state of the time difference between the reset gate signal and the horizontal driving signal by judging whether timing of rising of the reset gate signal and timing of rising of the horizontal driving signal coincide with each other.

15. An endoscope, comprising:
an image pickup device that outputs an analog output signal corresponding to an image of a subject;
a sampling circuit that carries out correlated double sampling for the analog output signal outputted by the image pickup device; and
at least one abnormal state detection circuit including:
a pulse generation circuit that generates a pulse having a pulse width corresponding to a relationship between timing of a driving signal for driving the image pickup device and timing of a sampling signal to be supplied to the sampling circuit; and
a detection circuit that detects an abnormal state of the timing of the sampling signal with respect to the timing of the driving signal in accordance with the pulse width of the pulse generated by the pulse generation circuit.

16. The endoscope according to claim 15,
wherein the detection circuit includes:
a counter that obtains a value corresponding to the pulse width of the pulse generated by the pulse generation circuit; and
a judgment circuit that judges whether the value obtained by the counter is within a predetermined range,
wherein the detection circuit detects the abnormal state of the timing of the sampling signal in accordance with a judgment result of the judgment circuit.

17. The endoscope according to claim 15,
wherein the detection circuit includes:
an integrator circuit that integrates the pulse generated by the pulse generation circuit; and
a voltage comparator that judges whether an output voltage of the integrator circuit satisfies a predetermined condition,
wherein the detection circuit detects the abnormal state of the timing of the sampling signal in accordance with a judgment result of the voltage comparator.
